(19) United States
(12) Patent Application Publication
(10) Pub. No.: US 2010/0146056 A1
(43) Pub. Date: Jun. 10, 2010

(54) Searching An Email System Dumpster

(75) Inventors: Ashish Consul, Redmond, WA (US); Suryanarayana M. Gorti, Redmond, WA (US); Shengquan Yan, Bellevue, WA (US); Andrei Marinescu, Issaquah, WA (US); Julian Alexander Zbogar-Smith, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/328,410

(22) Filed: Dec. 4, 2008

(51) Int. Cl. G06F 15/82

(52) U.S. Cl. 709/206

(57) ABSTRACT

A method is presented for searching for email messages that on a server computer. A request is received on the server computer to search for one or more email messages in one or more mailboxes on the server computer. Each of the one or more mailboxes includes a dumpster folder. The request includes search criteria including a parameter indicating whether the dumpster folder associated with a mailbox should be searched. The dumpster folder stores one or more email messages that have been deleted from a deleted items folder in the mailbox. One or more mailboxes that satisfy the search criteria in the request are identified. If the parameter indicates that the dumpster folder should be searched, the dumpster folder of each of the identified mailboxes that satisfy the search criteria is queried and any email messages in each dumpster folder that satisfy the search criteria are identified.

### BACKGROUND

Modern email systems include a deleted items folder that receives email messages from a user's inbox, sent items folder or other folders when a message is to be deleted. Some email systems also include a tombstone folder that receives the content of the deleted items folder when the deleted items folder is emptied. The tombstone folder, also known as a dumpster folder, provides a means for a user to recover email messages that were removed from the deleted items folder inadvertently.

Electronic discovery (also known as E-Discovery) refers to any process in which electronic data is sought, located, secured and searched with the intent of using it as evidence in civil or criminal litigation. The data is typically sought from electronic devices such as personal computers and email and other servers. While it is possible to search for certain email messages stored in a user's mailbox, such as those stored in the inbox, sent items folder and deleted items folder, dumpster folders, which are typically not accessible to a user, cannot be searched.

### SUMMARY

Embodiments of the invention are directed to searching for email messages on a server computer. A request is received on the server computer to search for one or more email messages in one or mailboxes on the server computer. Each of the one or more mailboxes is associated with a specific user. Each of the one or more mailboxes includes a dumpster folder. The request includes search criteria including a parameter indicating whether the dumpster folder associated with a mailbox should be searched. The dumpster folder stores one or more email messages that have been deleted from a user's mailbox.

One or more mailboxes that satisfy the search criteria in the request are identified. If the parameter indicates that the dumpster folder should be searched, the dumpster folder of each of the identified mailboxes that satisfy the search criteria is queried and any email messages in each dumpster folder that satisfy the search criteria are identified.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for performing E-Discovery searches.

FIG. 2 shows modules of an example mailbox server.

FIG. 3 shows example mailbox folders.

FIG. 4 shows an example structure for an application program interface used in a mailbox server to permit searches of a dumpster folder on the mailbox server.

FIG. 5 shows a flowchart for an example method for performing an E-Discovery search on a server computer.

FIG. 6 shows an operating environment with a system that can be used to search a dumpster folder on a server computer.

### DETAILED DESCRIPTION

The present application is directed to systems and methods for searching the dumpster folder in a user's mailbox in an email system. In the systems and methods, each email message in the dumpster folder is indexed so that it can be located by a search. A search request includes a parameter, typically a Boolean flag, which when set permits the dumpster folder to be searched. The dumpster folder is typically searched during E-Discovery to ensure that all personal data on a computer system is obtained. The parameter is typically not set during normal use, permitting normal searches of the email folders to occur without the overhead generated by an E-Discovery search.

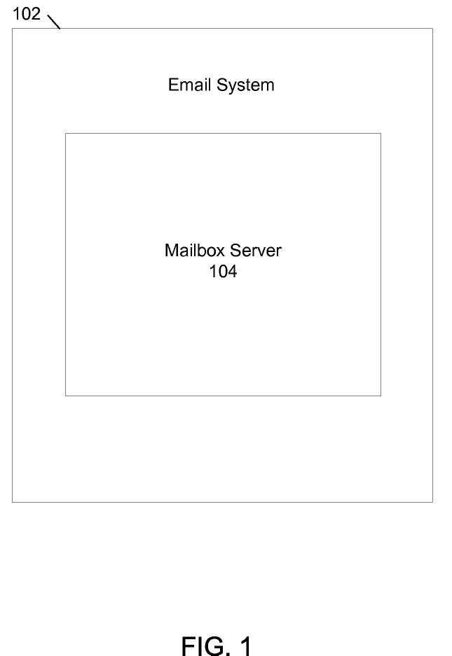

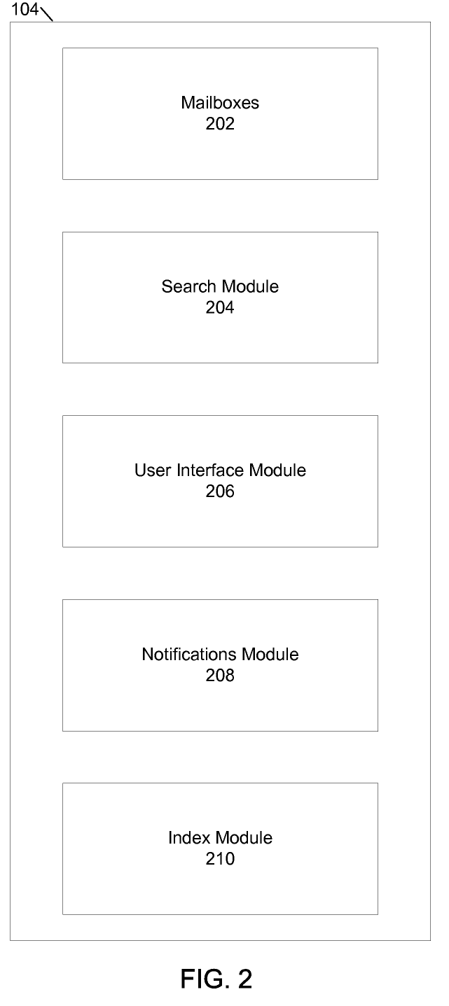

FIG. 1 shows an example email system 102 which includes an example mailbox server 104. FIG. 2 shows that the example mailbox server 104 includes one or more user mailboxes 202, a search module 204, a user interface module 206, a notifications module 208 and an index module 210. The example search module 204 searches one or more mailbox folders, including the dumpster folder. The example user interface module 206 permits a system administrator to access the user mailboxes and to perform searches on them. The example notifications module 208 generates event notifications when an email message is added to or removed from a mailbox folder. The example index module 210 provides an identifier for each email message in the mailbox, permitting the email messages to be searched.

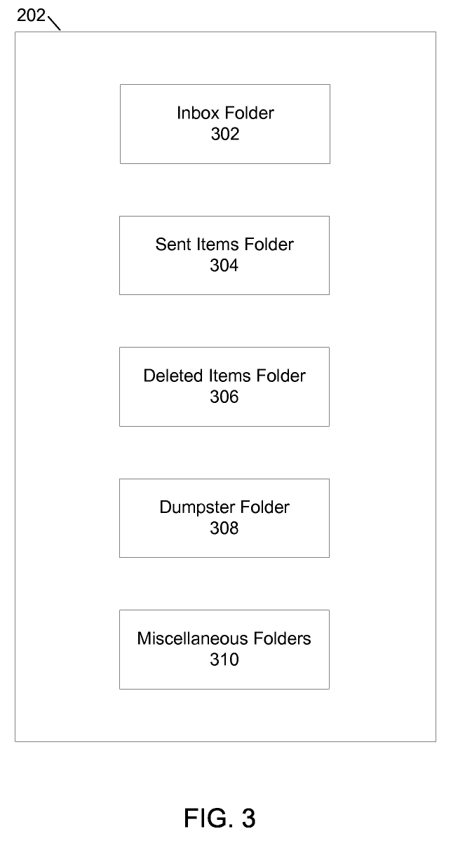

The example mailbox server 104 includes a plurality of mailboxes and each mailbox can have a plurality of folders. As shown in FIG. 3, an example user mailbox 202 includes an inbox folder 302, a sent items folder 304, a deleted items folder 306, a dumpster folder 308 and other miscellaneous folders 310. The example inbox folder 302, sent items folder 304 and deleted items folder 306 are all visible and accessible to a user. The example dumpster folder 308 is hidden from the user and is only accessible by the mailbox server software. Miscellaneous folders 310 include any additional mailbox folders such as junk items folders, drafts folders, outbox folders, etc.

In a typical email system, a user can delete an email message in the inbox folder 302, sent items folder 304 or one of the miscellaneous folders 310 by moving it to the deleted items folder 306. Typically, items remain in the deleted items folder 306 until the user or a system administrator empties the folder. Emails can be emptied from the deleted items folder 306 one at a time or in bulk. Occasionally, a user removes one or more email messages from the deleted items folder 306 inadvertently and wishes that the one or more items can be retrieved. For this reason, some email systems include a tombstone folder, such as example dumpster folder 308. The example dumpster folder 308 automatically receives all email messages removed from the deleted items folder 306 and stores these email messages for a predetermined period of time, a period of time that can be adjusted by a system administrator. In example embodiments, the deleted items folder 306 may be bypassed and the dumpster folder 308 may receive items directly from other mailbox folders. The system administrator can retrieve any items from the example dumpster folder 308 at the request of a user and move those items into a user accessible folder.

In order to accommodate a search of the example dumpster folder 308, the email messages in the dumpster folder are indexed. The email messages can be indexed during a crawl mode when a content index for the mailbox is created or updated. In the crawl mode, all email messages in the dumpster folder, as well as all email messages in the other mailbox folders, are indexed with an identifier that permits the email messages to be located during a search.

Email messages are also indexed during a notifications mode. Whenever a new email message is added to a user's mailbox, whenever an existing email message is changed by the user and whenever an email message is deleted, an event is generated and the email message is indexed. A new index identifier is created for a new email message and the existing index is updated for changed or deleted email messages. Notifications occur for changed and added messages in the dumpster folder as well as for other mailbox folders. So if an email message is deleted from an email folder and transferred to the dumpster folder, indexing for the deleted email message is maintained.

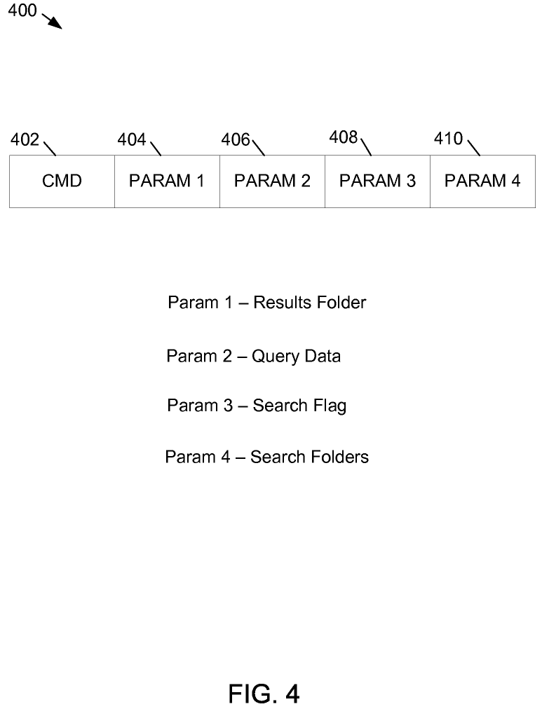

FIG. 4 shows the structure 400 of an example application program interface (API) that can be used in an E-Discovery search. The example search API 400 includes a command name 402, such as SearchMailbox and four example parameters. Example parameter 1 (404), provides the name of a virtual folder that holds the results of the search. Example parameter 2 (406), provides query data for the search. This can include one or more names, words, dates or other data to be searched for. Example parameter 3 (408) provides a search flag that when set indicates that the dumpster folder 308 is to be searched. If the search flag is not set, the dumpster folder 308 is not searched. Typically, the search flag is a Boolean flag incorporated in a string. An example string with a Boolean flag is “Search Dumpster=TRUE”. Example parameter 4 (410) provides the names of mailbox folders to be searched. It is understood that more or fewer parameters may be included in the example API.

The example API 400 is called when a mailbox search is initiated during an E-Discovery or other search. An E-Discovery search can only be done by authorized individuals, such as members from a legal department, whose access is granted by a system administrator. The system administrator or the authorized individuals may create a command string with search information using a command line application such as a cmdlet. The cmdlet permits a command name and parameter data to be entered in string form. When the cmdlet is excuted, the example search API 400 is called. Because the example mailbox server 104 is organized at the mailbox level, the cmdlet may result in several API calls, each call querying a specific mailbox. Thus, multiple mailboxes may be queried during an E-Discovery search. Alternatively, command and parameter data may be entered by authorized individuals via a graphical user interface.

When searching for E-Discovery information, it is often necessary to do string searches for specific dates. An example E-Discovery request may be to obtain all emails from John Doe to Mary Smith from Jun. 21, 2004 to Sep. 30, 2004. Some email systems represent and index date fields numerically, making it difficult to do string searches on these fields. However, it is possible to represent numbers by a set of strings whose lengths reflect the place value of digits in the number. Representing numbers in this manner permits a more efficient numerical search.

A date may be thought of as three numeric properties—year, month and day. For example, for the date May 11, 2008, the year 2008 can be represented by three hexadecimal digits (nibbles), 7 DB, whose value equals 2008. Similarly, the month 05 can represented as 5 in hexadecimal and the day 11 can be represented as B in hexadecimal.

Further, each nibble can be represented as a string comprising a prefix string and a string of letters corresponding to the value of each nibble. For example, the nibble 7 can be represented by the prefix string “d3a2t1e” plus “qqqqqqq”, where the letter “q” appears seven times in a string, corresponding to the value 7 in the nibble. Similarly, the nibble D can be represented by the prefix string “d3a2t1e” plus “qqqqqqqqqqqqq”, where the letter “q” appears 13 times in a string, corresponding to the hexadecimal value D in the nibble. Similarly, the nibble B can be represented by the prefix string “d3a2t1e” plus “qqqqqqqqqqq”, where the letter “q” appears 11 times in a string, corresponding to the hexadecimal value B in the nibble. In this manner, a search for the year 2008 can be done by performing matches on the strings “d3a2t1eqqqqqqq”, “d3a2t1eqqqqqqqqqqqqq” and “d3a2t1eqqqqqqqqqqq”. A different year may have a different prefix string.

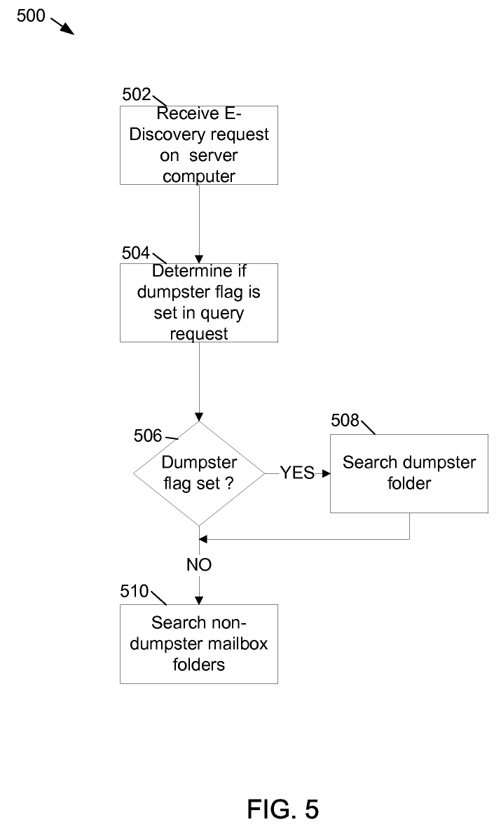

FIG. 5 shows a flowchart for an example method for performing an E-Discovery search on a server computer. At operation 502 an E-Discovery request is received on the server computer. The E-Discovery request typically is directed to locate emails for one or more users within a specified timeframe. The E-Discovery request includes a search string including one or more parameters. One of the parameters is a flag that specifies whether the dumpster folder in a user's mailbox should be searched. At operation 504, a determination is made as to whether the dumpster flag is set in the query request. If the dumpster flag is set at operation 506, the dumpster folder is searched at operation 508. Then, the non-dumpster mailbox folders are searched at operation 510. If the dumpster flag is not set at operation 506, the dumpster folder is not searched and control proceeds to operation 510 where the non-dumpster email folders are searched. It is understood that in other embodiments the non-dumpster email folders may be searched before the dumpster folder.

The example flowchart in FIG. 5 shows an example E-Discovery search for one user mailbox. Depending on the E-Discovery request, more than one user mailbox and dumpster may be searched. In example embodiments, the server computer may provide a separate search module for each search so that a plurality of user mailboxes and dumpsters may be searched in parallel.

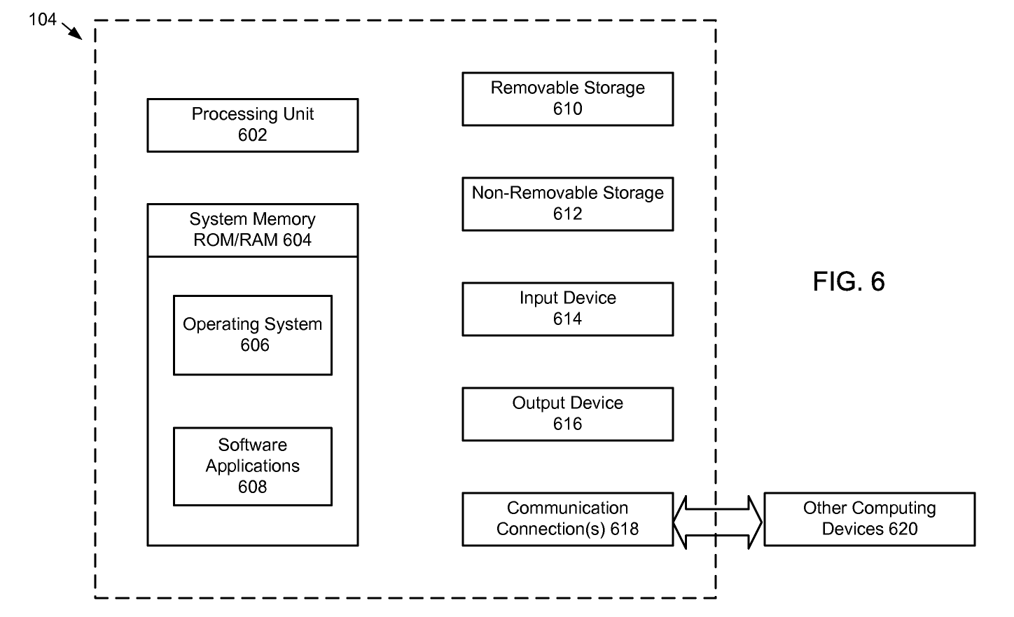

With reference to FIG. 6, one exemplary system for implementing the invention includes a computing device, such as computing device 104. In a basic configuration, the computing device 104 typically includes at least one processing unit 602 and system memory 604. Depending on the exact configuration and type of computing device, the system memory 604 may be volatile (such as RAM), non-volatile (such as ROM, flash memory, etc.) or some combination of the two. System memory 704 typically includes an operating system 606 suitable for controlling the operation of a networked personal computer, such as the WINDOWS® operating systems from MICROSOFT CORPORATION of Redmond, Wash. or a server, such as Windows Sharepoint Server 2007, also from MICROSOFT CORPORATION of Redmond, Wash. The system memory 604 may also include one or more software applications 608 and may include program data.

The computing device 104 may have additional features or functionality. For example, the computing device 104 may also include additional data storage devices (removable and/or non-removable) such as, for example, magnetic disks, optical disks, or tape. Such additional storage is illustrated in FIG. 6 by removable storage 610 and non-removable storage 612. Computer storage media may include volatile and nonvolatile, removable and non-removable media implemented in any method or technology for storage of information, such as computer readable instructions, data structures, program modules, or other data. System memory 604, removable storage 610 and non-removable storage 612 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 104. Any such computer storage media may be part of device 104. Computing device 104 may also have input device(s) 614 such as keyboard, mouse, pen, voice input device, touch input device, etc. Output device(s) 616 such as a display, speakers, printer, etc. may also be included. These devices are well known in the art and need not be discussed at length here.

The computing device 104 may also contain communication connections 618 that allow the device to communicate with other computing devices 620, such as over a network in a distributed computing environment, for example, an intranet or the Internet. Communication connection 618 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media.

The various embodiments described above are provided by way of illustration only and should not be construed to limiting. Various modifications and changes that may be made to the embodiments described above without departing from the true spirit and scope of the disclosure.

What is claimed is:

1. A method performed on a server computer to search for email messages on the server computer, the method comprising:
receiving a request on the server computer to search for one or more email messages in one or mailboxes on the server computer, each of the one or more mailboxes being associated with a specific user, each of the one or more mailboxes including a dumpster folder, the request including search criteria, the request including a parameter indicating whether the dumpster folder associated with a mailbox should be searched, the dumpster folder storing one or more email messages that have been deleted from a user's mailbox;
identifying one or more mailboxes that satisfy the search criteria in the request; and
if the parameter indicates that the dumpster folder should be searched, querying the dumpster folder of each of the identified mailboxes that satisfy the search criteria in the request and identifying any email messages in each dumpster folder that satisfy the search criteria in the request.

2. The method of claim 1, further comprising copying the identified email messages to a folder on the server computer.

3. The method of claim 1, wherein the parameter is a Boolean flag.

4. The method of claim 1, wherein each email message in the dumpster folder is indexed.

5. The method of claim 1, wherein the request is an electronic discovery request.

6. The method of claim 1, wherein the search criteria includes at least one date, the date including a year and month, both the year and month indexed in the server computer as a numeric field that includes one or more numbers.

7. The method of claim 6, wherein each number is represented by one or more strings, each string corresponding to a nibble in the number, the length of each string corresponding to value of the associated nibble.

8. The method of claim 7, wherein each string includes a unique prefix string.

9. The method of claim 8, wherein a search for a date field in a query request includes one or more string matches on nibbles in the date field.

10. The method of claim 1, further comprising creating a content index for a dumpster folder by crawling the dumpster folder.

11. The method of claim 1, further comprising updating a content index in the mailbox when an email message is added to the dumpster folder for a mailbox.

12. The method of claim 11, where a notification of a message being added to the dumpster folder is provided by a mailbox service on the server computer.

13. The method of claim 1, wherein the request is generated by a graphical user interface on the server computer.

14. A system for management of electronic discovery on a computing device, the system comprising:
a search module; and
one or more mailbox modules, each mailbox module including an inbox folder, a sent items folder, a deleted items folder and a dumpster folder, the dumpster folder receiving input from the deleted items folder, the dumpster folder containing one or more email messages to be removed from the server computer when the one or more email messages have been stored in the dumpster folder for a specified period of time;
wherein, the search module searches one or more mailbox module folders, including the dumpster folder, during an electronic discovery request.

15. The system of claim 14, wherein the search module includes an application program interface, the application program interface including a parameter, that when set, permits searching the dumpster folder.

16. The system of claim 14, further comprising a user interface module, the user interface module permitting an authorized user to enter a query string to initiate an electronic discovery request in the system.

17. The system of claim 14, further comprising a notifications module, the notifications module generating a notification when an email is added to or deleted from a mailbox module folder.

18. The system of claim 14, further comprising an indexing module, the indexing module providing an index for each email message in each email folder so that each email message can be located during a query search of the system.

19. A computer-readable storage medium comprising instructions that, when executed by a server computer, cause the server computer to:
receive a request on the server computer to search for one or more email messages in one or mailboxes on the server computer, each of the one or more mailboxes being associated with a specific user, each of the one or more mailboxes including a dumpster folder, the request including search criteria, the request including a parameter indicating whether the dumpster folder associated with a mailbox should be searched, the dumpster folder storing one or more email messages that have been deleted from a user's mailbox;
identify one or more mailboxes that satisfy the search criteria in the request; and
if the parameter indicates that the dumpster folder should be searched, querying the dumpster folder of each of the identified mailboxes that satisfy the search criteria in the request and identifying any email messages in each dumpster folder that satisfy the search criteria in the request.

20. The method of claim 19, further comprising copying the identified email messages to a folder on the server computer.
